(19) United States
(12) Patent Application Publication
(10) Pub. No.: US 2011/0159230 A1
(43) Pub. Date: Jun. 30, 2011

(54) Area Pad

(76) Inventor: Margaret J. Goode, Littleton, CO (US)

(21) Appl. No.: 12/647,542

(22) Filed: Dec. 28, 2009

(51) Int. Cl. B60N 3/04; B32B 5/08

(52) U.S. Cl. 428/92

(57) ABSTRACT

An area pad that is movably positioned upon a surface, supporting an article, the pad includes a base with first and second side portions, and an outer periphery. Also a plurality of fibers each with a proximal and a distal end portion, each fiber having a thickness and a length parallel to a longitudinal axis, each proximal end is affixed to the second side, each proximal end is spaced apart from an adjoining proximal end by at least a thickness forming an open volume, and each length is at least ten times the thickness. Further included is a low friction layer affixed to the first side, wherein the layer contacts the surface, the layer allows free relative movement to the surface. Also a flexible binding is affixed to the outer periphery, the binding contacts a portion of the proximal ends to substantially position each longitudinal axis perpendicular to the base.

### TECHNICAL FIELD

The present invention relates generally to an area pad for protecting a selected area of an article that is disposed on either side of the pad. More specifically, the present invention relates to an area pad for selectively positioning the pad as between a shoe heel and a surface for the purpose of protecting the shoe heel from abrasion and/or dimpling loading from a force executed at a small area of the heel from an individual's weight and muscle force, while entering, exiting, or driving a vehicle.

### BACKGROUND OF INVENTION

The investment that an individual makes in their shoes can be significant, be it men's or woman's shoes wherein high end shoes can cost upwards of $1,000 or more for a pair, necessitating that the individual would take extra care with their expensive shoes, such that they are not worn when it is wet or rainy outside or when snow and slush are present, in addition to not wearing their expensive shoes where one would have to walk over mud, gravel, and the like. Further in normal use, only the sole or bottom of the shoe is exposed to the surface, wherein the shoe upper is not exposed to the potential coarse surface, as the shoe upper typically is very susceptible to abrasive damage from a coarse surface, as the shoe upper is typically a fine smooth leather of some type that could be easily cut, gouged, and/or discolored by coming into contact with an abrasive surface.

Thus when an individual drives a car, the unusual situation occurs wherein the shoe upper, and in particular the exterior heel of the shoe upper comes into contact with the surface, thus putting the heel into risk for abrasion, wherein this undesirable situation is exacerbated by several things; firstly the carpeted surface of the car floor typically has a higher grit level than house carpet due to the dirt, sand, pebbles, and so on being tracked directly from the street into a small concentrated area of carpet in the car, as opposed to house carpet that allows for distribution of the grit over a much wider area, further the car carpet is typically a much shorter knap or a Berber type which exposes the grit to a greater degree than a longer knap house carpet. Secondly, during driving the individual operates the accelerator and brakes which introduces ongoing relative movement as between the shoe upper, in particular the heel portion and the car carpet, ultimately creating the perfect environment for abrasion to occur between the shoe heel and the car carpet, unfortunately resulting in obvious damage to the heel upper of the shoe in the form of scratches, gouges, discoloration, and surface damage to the shoe upper leather.

This issue has been recognized in the prior art starting with U.S. Pat. No. 3,114,272 to Sawyer that discloses a separable heel and counter protector for vehicles having two main parts to its construction: a pad-like member and a bottom member. The bottom member in Sawyer is adapted to hold in position a lamb or sheepskin or other suitable material at the edges, see column 1, lines 53-59. The other main part of the Sawyer device resides in the provision of a pan-like holder, and has a flat bottom body portion which has longitudinal turned-in flanges at the edges, see column 2, lines 3-8. The protector in Sawyer is selectably positioned wherein screws are permanently installed by means of a screwdriver or the like, to the floor board of the vehicle so that the holder is more or less permanently secured in position. When this has been done in Sawyer the pad is either slid in from the one end of the pan-like holder or is tucked in at the edges.

Further, in Sawyer the pad is positioned such that the snap fasteners are snapped into corresponding cooperating members and the pad is thereby secured in a fixed position with longitudinal edges of the pad bottom member 12 thereof covered and protected by the flanges 26. It is noted that Sawyer teaches that the preferred material in contact with the shoe is lamb or sheepskin that is highly dense and not allowing grit to easily penetrate down into the lamb or sheepskin to lessen abrasion, thus requiring frequent cleaning of the pad, such that the grit would reside upon the surface in contact with the shoe causing abrasion, see column 2, lines 34-42. The aforementioned fixed and secured attachment in Sawyer of the pad to the floor board would make for a difficult removal of the pad from the floor board that would be required for frequent cleaning of the pad. Further, in Sawyer as the pad is fixedly secured to the floor board the relative movement of the shoe to the pad would be increased leading to increased abrasion which is undesirable, see FIGS. 1, 2, and 6.

Continuing in the prior art in U.S. Pat. No. 4,262,048 to Mitchell, disclosed is a heel protector having a protector member that includes a large pad for placement on the floorboard below and to the rear of the accelerator pedal, see FIG. 1. The pad in Mitchell has a cushioning layer with a convoluted egg crate type upper surface, see FIGS. 1 and 3. The upper surface in Mitchell includes a plurality of relatively large peaks surrounded by valleys, wherein the peaks remove the debris from the shoe, allowing the debris to fall into the valleys. A strip of film in each valley of Mitchell is gathered to receive debris in folds disposed within the valleys, wherein the folds serve to prevent the debris from further contact with the shoe heel, see column 1, lines 50-59 and see FIG. 3 in particular.

Problems with Mitchell are that with the debris being removed from the shoe heel by the peaks causes heel abrasion from the start in the process of removing the debris from the heel, see column 1, lines 55-60 and column 3, lines 25-30. Also, the peaks are constructed from foam which would not allow the debris to fall into the peak, thus undesirably keeping all of the debris initially as against the heel, see column 2, lines 15-20. Further, in Mitchell the thin film 29 is disposed over each valley that is in a distance gap of three-eighths inch to one-eighth inch, thus limiting the size of the debris to three-eighths inch to one-eighth inch, see column 2, lines 53-60. Another problem with Mitchell, is that the thin film 29 attempts to act as a debris retaining barrier resulting in two issues, in that the shoe heel must push the debris through the film which adds potential additional abrasion and with the debris trapped under the film, the protector cannot be cleaned easily, see column 2, lines 53-60 and column 3, lines 25-35.

Further, in U.S. Pat. No. 4,749,602 to Russell disclosed is a lamb's wool heel saver mat having an upper layer of lamb's wool secured to a lower layer of rubber. The lower layer of rubber in Russell has a plurality of skid resistant cleats located on the lower side to fixedly grip the floor carpet. The lamb's wool in Russell would have the same anti-grit absorption property problems as described in Sawyer, wherein the grit tends to reside on top on the highly dense lamb's wool thereby causing additional abrasion to the heel. Further, in Russell the cleats prevent the mat from moving out of its position which acts to put the full amount of relative movement of the heel to the lamb's wool between the heel and the lamb's wool, thus not reducing the relative heel movement at the interface from the heel saver to the floor carpet, also making repositioning of the heel saver to a cleaner area under the heel more difficult in addition to more difficulty in removing the heel saver from the floor carpet for cleaning.

Next, in U.S. Pat. No. 4,910,061 to St. Julian, disclosed is a shoe heel saving pad that is installable on the floor of an automobile in near adjacency to the driver's accelerator pedal. The pad structure in St. Julian is designed to absorb forces developed by a woman driver when she presses her foot down on the pedal, wherein such forces can, over time, cause the heel area of the woman's shoe to wear away prematurely, i.e. prior to other shoe surfaces. St. Julian provides a pad structure that distributes and absorbs forces associated with shoe pressure on an accelerator pedal, thereby reducing show heel wear and preserving shoe life, see column 1, lines 6-16. When a woman is driving the automobile the heel of her shoe will engage the upper face of the pad in St. Julian while she is applying foot pressure to the accelerator pedal with the rear edge of the heel sinking into the pad surface, such that a large pad area will exert a relatively low unit area reaction force against the shoe heel.

St. Julian attempts to minimize premature wearing away of the shoe heel that can occur, over time, when the rear edge of the shoe heel is repeatedly pressed down against a relatively rigid automobile floor surface. Although St. Julian decreases the unit area loading from the heel force as against the vehicle floor, there is no teaching related to the problem of grit trapped between the heel and the pad surface, as St. Julian teaches a short knap surface such as velvet to contact the heel, see column 2, lines 64-68, which intensifies the cause of abrasion by not allowing grit to recede away from the heel easily. Further another problem in St. Julian is the fixed contact from the buttons 36, see column 2, lines 22-29, which is as between the pad the floor, which as in Russell and Sawyer, puts the full relative movement between the heel and the pad to stay as between the heel and pad further increasing the abrasion between the heel and grit on the pad.

Continuing, in U.S. Pat. No. 2,680,385 to Estin disclosed an anti-scuffing floor mat for containment of abrading matter within a combination of trap-like pockets, within which pockets abrading matter may fall and accumulate without being presently available to scuff or abrade the finish surface of the back of the shoes. The floor mat in Estin is formed of rubber or equivalent material, of an area or zone having parallel ribs and grooves in its top surface and of an area or zone comprising a cluster of flexible and pliant nibs extending therefrom for yielding under pressure of the shoes so as to create a multi-cellular surface within which abrading matter may accumulate without deleterious effect upon the heels of shoes imposed there on or brought into contact therewith, see column 1, lines 20-36. Estin would have similar problems to Mitchell as previously described wherein the peaks of the nibs 11 would still permit the abrading matter to come into direct contact with the shoe heel, further as the spaces between the ribs fill with abrading matter there would be nothing between the abrading matter and the shoe heel to lessen abrasion to the heel.

What is needed is an area pad that is adapted to any type of shoe and any shoe size, such that men's dress shoes or women's high heel shoes are both accommodated in any shoe size, thus not requiring any effort on the part of the individual to attach or remove anything from their shoe. Further, the area pad would be easily cleanable, because as previously stated the carpet floor surface on a car accumulates grit rather quickly and needs to be cleaned with a minimum of effort, in addition, the knap height of the area pad is desirably longer and less dense that the typical shorter higher density knap of car carpet in order to better protect the shoe heel from abrasion by giving the grit more space to settle down toward the area pad backing and also allowing the area pad to accommodate more grit before cleaning. Another desirable feature would be a low friction backing that is oppositely disposed from the knap portion that has a low friction surface and having a periphery band to retain the knap portion thus helping keep the tall long knap upright for maximum effectiveness in holding the grit near the backing and away from the shoe heel and further allowing easy relative movement as between the surface or car floor and the backing to lessen the remaining relative movement as between the shoe and the knap.

Thus a desired area pad would have a tall or high fiber knap that is disposed loosely to itself, i.e. with larger spaces as between each fiber to easily allow even larger grit to fall quickly away from the shoe heel down into the tall fiber roots, further the area pad would have a laterally semi free moving base in relation to the floor carpet to reduce the relative movement as between the area pad and the heel via some of the heel movement translating to an interface between the area pad and the floor carpet, as the area pad loosely rests against the floor carpet, which also allows for easy re-positioning of the area pad against the heel to utilize a cleaner portion of the area pad to come into contact with the heel, and to facilitate quick and easy removal of the area pad from the floor carpet for cleaning to remove the built-up grit. In other words, the area pad accomplishes functions that the floor carpet cannot by having a tall loose fiber, a loose resting against the floor carpet, the quick and easy ability to re-position the area pad, and to quickly and easily remove the area pad for cleaning, in addition to making the area pad machine washable. Therefore the overall goal is to put the fibers in-between the shoe heel and grit to the greatest extent possible.

### SUMMARY OF INVENTION

Broadly, the present invention is an area pad adapted to be movably positioned upon a surface, wherein the area pad supports an article; the area pad includes a flexible planar base including a first side portion, a second side portion, and an outer periphery. Further the area pad includes a plurality of fibers each having a proximal end portion and an oppositely disposed distal end portion, further each fiber having a thickness perpendicular to a length that is co-axial to a longitudinal axis that extends from the proximal end portion to the distal end portion. Wherein each fiber proximal end portion is affixed to the base second side portion and each fiber distal end portion is free, each fiber proximal end portion is spaced apart from an adjoining fiber proximal end portion by at least a fiber thickness forming an open volume, and each fiber has a length of at least ten (10) times of the fiber thickness. Also included in the area pad is a low friction layer affixed to the base first side portion, wherein the low friction layer is in contact with the surface, wherein the layer allows free relative movement between the layer and the surface. Also included in the area pad is a flexible binding affixed to the outer periphery, wherein the binding is in contact with a portion of the fiber proximal end portions being operational to substantially position each longitudinal axis perpendicular to the planar base.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of the area pad from the plurality of fibers side plus a portion of the flexible binding;

FIG. 2 shows a flat plan view of the area pad from the plurality of fibers side plus the flexible binding including the side dimensions;

FIG. 3 shows a perspective view of the area pad from the layer side with the plurality of fibers and the flexible binding;

FIG. 4 shows a flat plan view of the area pad from the layer side with the plurality of fibers and the flexible binding;

FIG. 5 is a side elevation view of the area pad showing the plurality of fibers and the flexible binding;

FIG. 6 shows cross section 6-6 from FIG. 1 showing the plurality of fibers, the base, and the binding;

FIG. 7 shows expanded view 7-7 from FIG. 6, wherein cross sectional detail is shown that includes the plurality of fibers with expanded distal end portions plus proximal end portions, the base, the binding, the surface or vehicle floor, the article or shoe heel, and the debris;

FIG. 8 shows a use perspective view of the area pad or protection carpet movably positioned upon the surface or the vehicle floor in supporting an article or women's shoe heel; and

FIG. 9 shows a use perspective view of the area pad or protection carpet movably positioned upon the surface or the vehicle floor in supporting an article or men's shoe heel.

### REFERENCE NUMBERS IN DRAWINGS

30 Area pad
35 Protection carpet
40 Surface
45 Vehicle floor
50 Movable positioning of the pad 30 upon the surface 40
55 Article
60 Shoe heel
65 Debris
70 Flexible planar base
75 First side portion of the flexible planar base 70
80 Second side portion of the flexible planar base 70
85 Outer periphery of the flexible planar base 70
90 Generally square shaped base 70
95 Generally square shaped base 70 side dimension
100 Plurality of fibers
105 Proximal end portion of each fiber 100
110 Distal end portion of each fiber 100
115 Expanded thickness of each fiber distal end portion 110
120 Contact of each expanded thickness 115 to one another
125 Flexing of each expanded distal end portion thickness 115
130 Partial barrier of the expanded distal end portion thickness 115 and the debris 65
135 Thickness of each fiber 100
140 Length of each fiber 100
145 Not exceeding about one-half of the length 140 by the expanded in thickness distal end portion 115
150 Perpendicular orientation of each thickness 135 to each length 140
155 Longitudinal axis of each fiber 100
160 Affixed proximal end portion 105 to the base second side portion 80
165 Free distal end portion 110
170 Spaced apart distance of at least a thickness 135
175 Open volume formed by the spaced apart distance 170
180 Low friction layer
185 Low friction layer 180 affixed to the base first side portion 75
190 Contact of the surface 40 with the low friction layer 180
200 Free relative movement between the layer 180 and the surface 40
205 Flexible binding
210 Flexible binding 205 affixed to the outer periphery 85
215 Flexible binding 205 partially encasing the layer 180 at the outer periphery 85
220 Contact of the flexible binding 205 with a portion of the fiber proximal end portions
105
225 Perpendicular position of each longitudinal axis 155 to the planar base 70
230 Partial relative movement of the base 70 to the surface 40 or vehicle floor 45
235 Movement of the shoe heel 60 or article 55
240 Relative movement as between the plurality of fibers 100 and the shoe heel 60 or article 55
245 No attachment as between the layer 180 and binding 205 as being relative to the vehicle floor 45 or surface 40
250 Manual instant movement of the shoe heel protection carpet 35 or area pad 30 as against the vehicle floor 45 or surface 40

### DETAILED DESCRIPTION

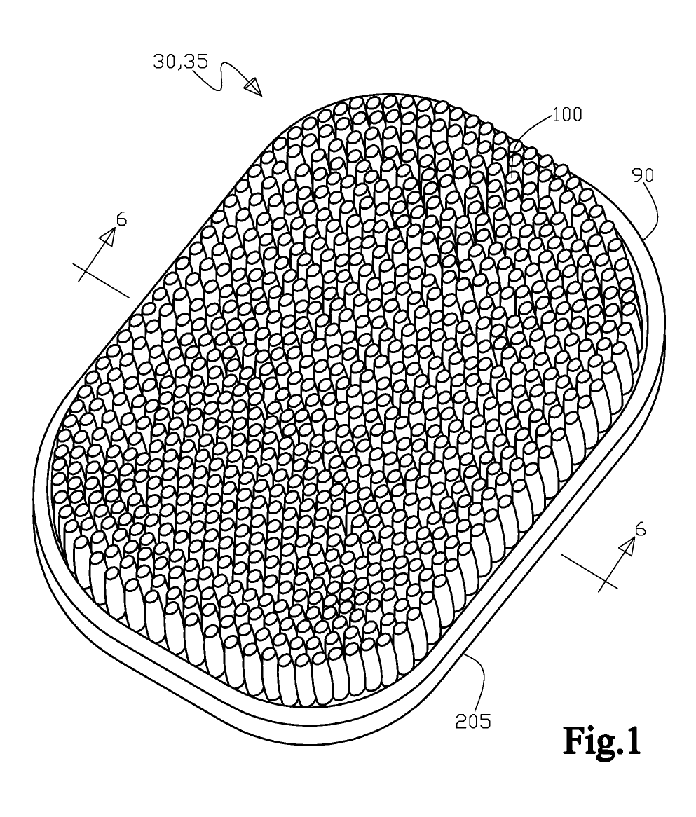

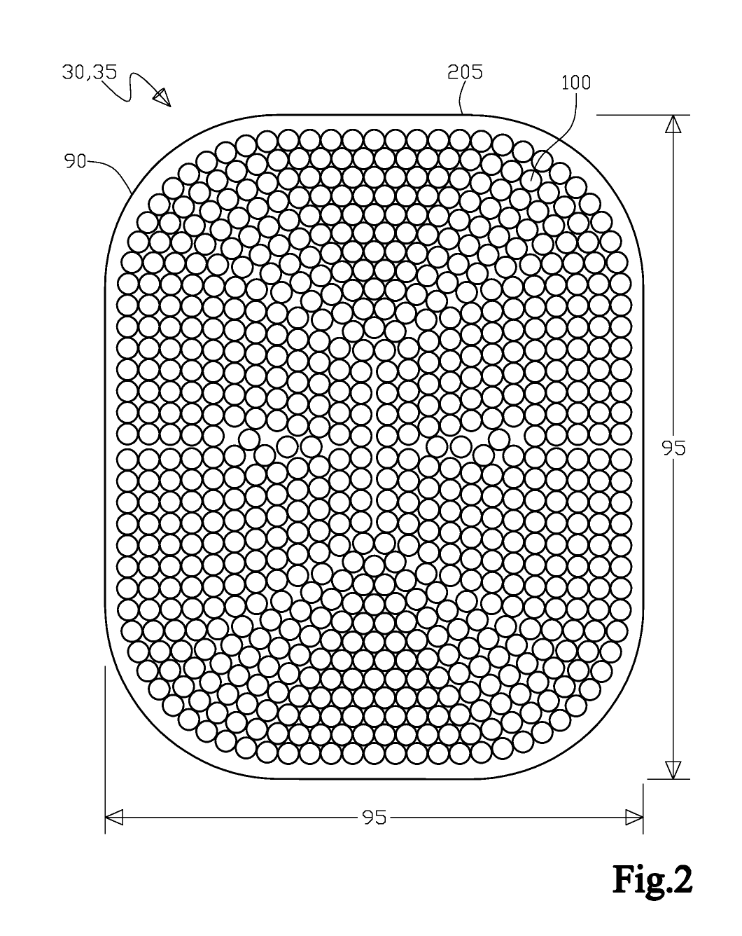

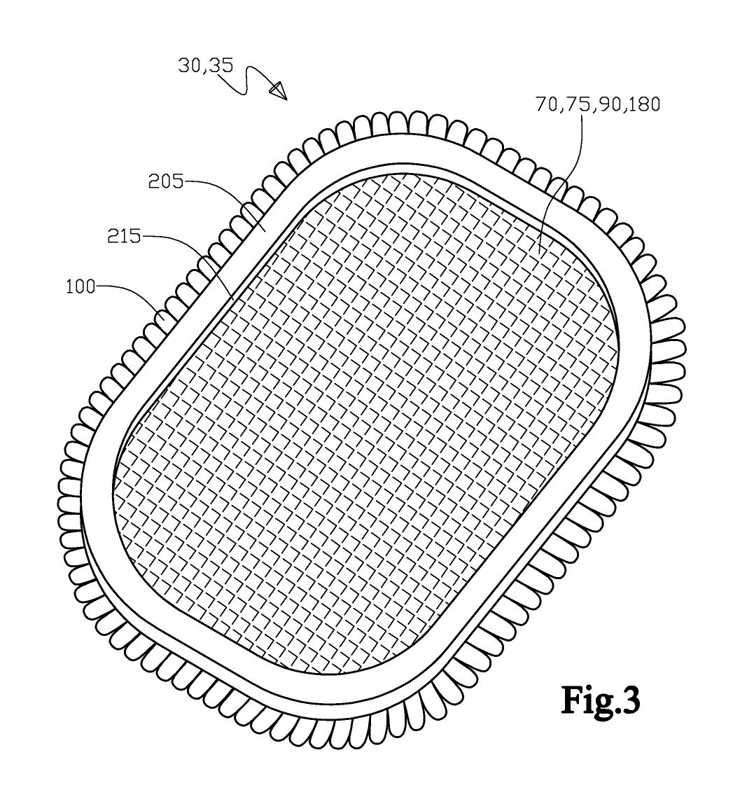

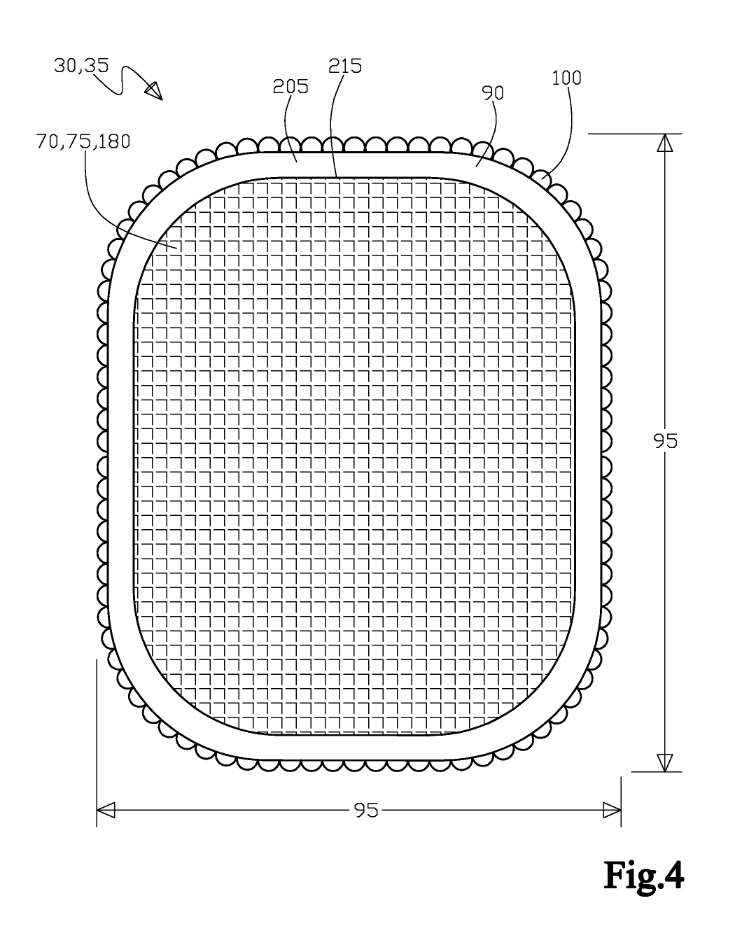

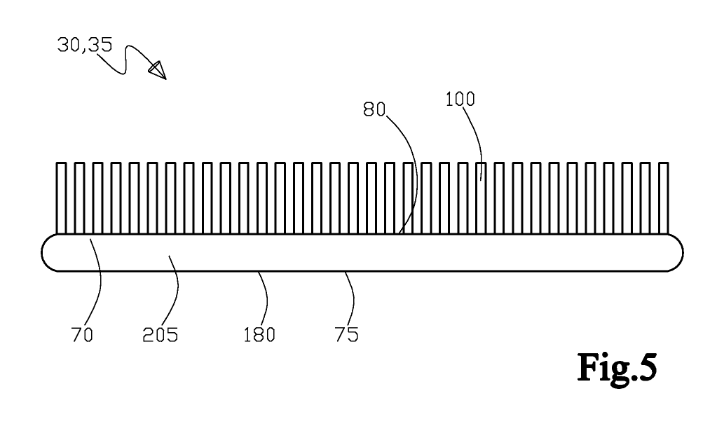

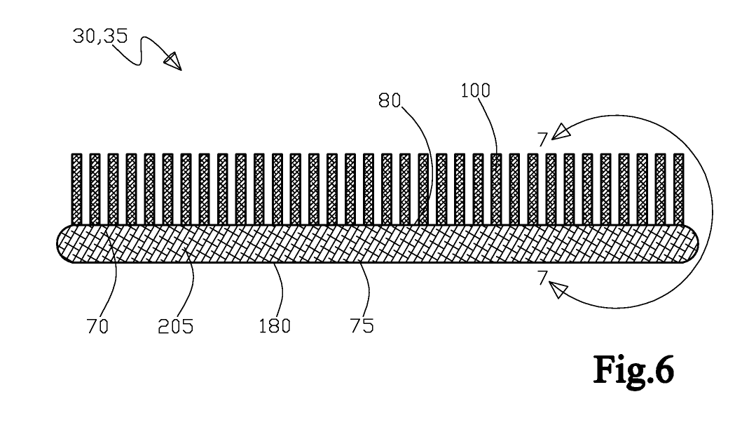

With initial reference to FIG. 1 shown is a perspective view of the area pad 30 from the plurality of fibers 100 side plus a portion of the flexible binding 205, FIG. 2 shows a flat plan view of the area pad 30 from the plurality of fibers 100 side plus the flexible binding 205 including the side dimensions 95, and FIG. 3 shows a perspective view of the area pad 30 from the layer side 180 with the plurality of fibers 100 and the flexible binding 205. Continuing, FIG. 4 shows a flat plan view of the area pad 30 from the layer side 180 with the plurality of fibers 100 and the flexible binding 205, FIG. 5 is a side elevation view of the area pad 30 showing the plurality of fibers 100 and the flexible binding 205, and FIG. 6 shows cross section 6-6 from FIG. 1 showing the plurality of fibers 100, the base 70, and the binding 205.

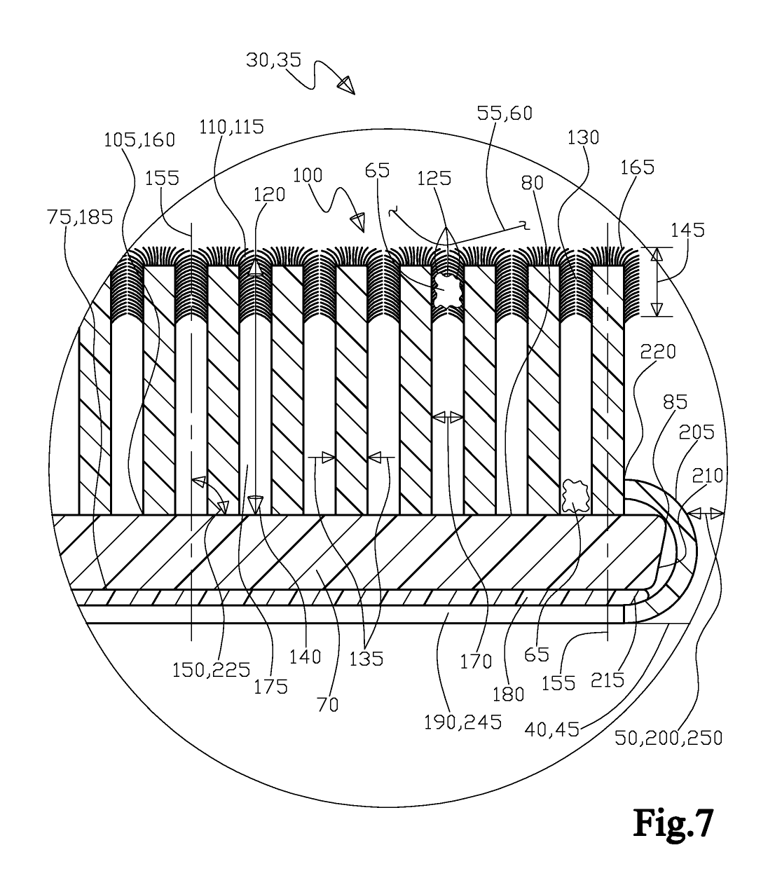

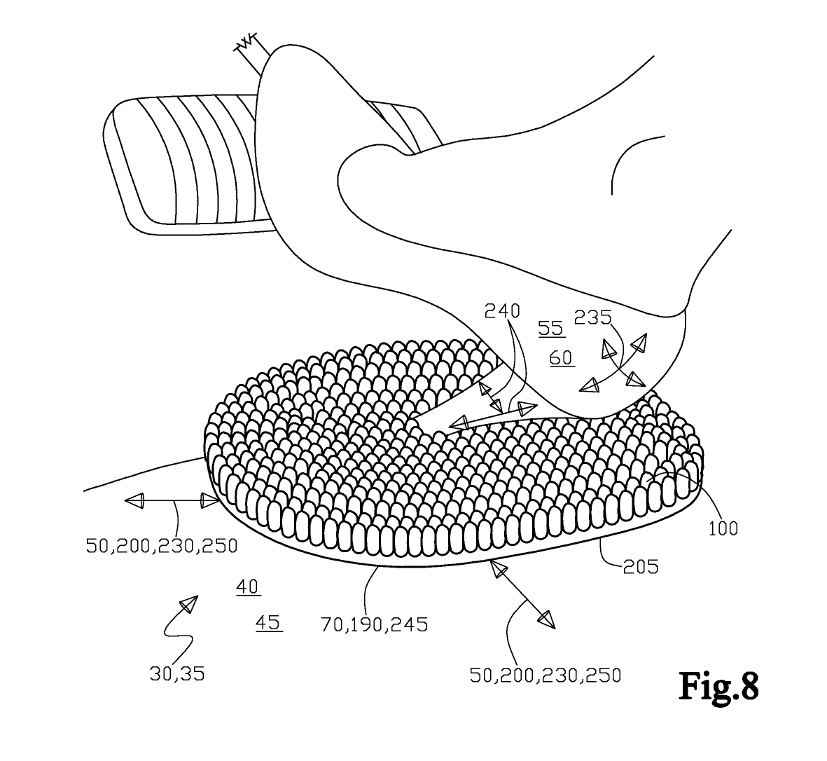

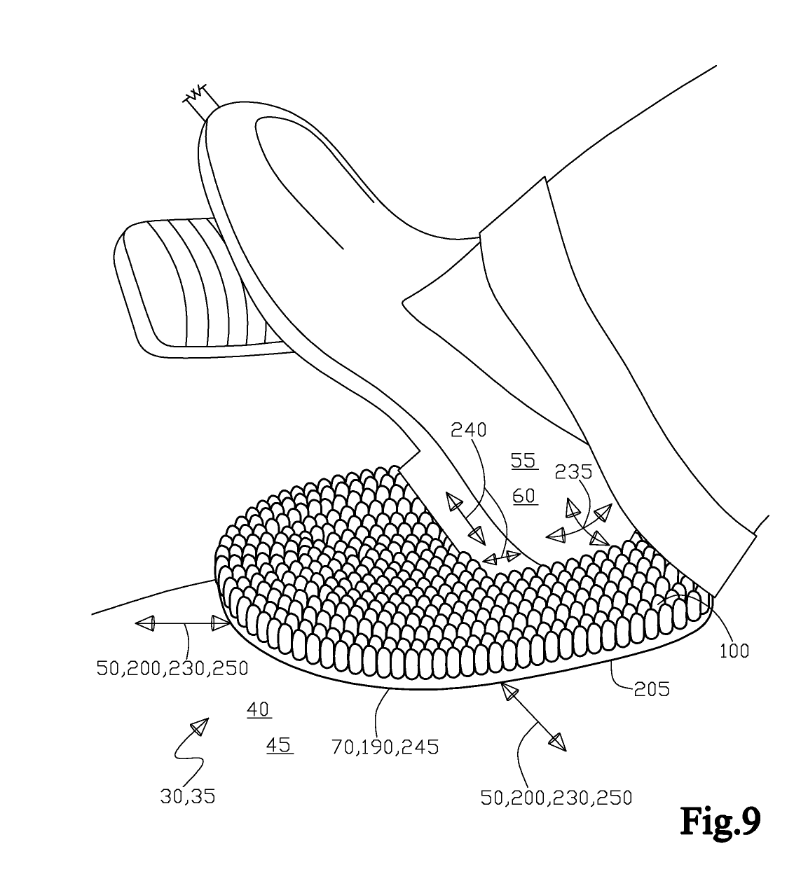

Next, FIG. 7 shows expanded view 7-7 from FIG. 6, wherein cross sectional detail is shown that includes the plurality of fibers 100 with expanded distal end 110 portions 115 plus proximal end portions 105, the base 70, the binding 205, the surface 40 or vehicle floor 45, the article 55 or shoe heel 60, and the debris 65. Further, FIG. 8 shows a use perspective view of the area pad 30 or protection carpet 35 movably positioned 50 upon the surface 40 or the vehicle floor 45 in supporting an article 55 or women's shoe heel 60. Yet further, FIG. 9 shows a use perspective view of the area pad 30 or protection carpet 35 movably positioned 50 upon the surface 40 or the vehicle floor 45 in supporting an article 55 or men's shoe heel 60.

Broadly, in referring to FIGS. 1 through 9, the present invention is an area pad 30 adapted to be movably positioned 50 upon a surface 40, see in particular FIGS. 8 and 9, wherein the area pad 30 supports an article 55, the area pad 30 also includes a flexible planar base 70 including a first side portion 75, a second side portion 80, and an outer periphery 85, see FIGS. 1, 3, 6, and 7. Further the area pad 30 includes a plurality of fibers 100 each having a proximal end portion 105 and an oppositely disposed distal end portion 110, also each fiber 100 having a thickness 135 perpendicular 150 to a length 140 that is co-axial to a longitudinal axis 155 that extends from the proximal end portion 105 to the distal end portion 110, as best shown in FIG. 7. Wherein each fiber 100 proximal end portion 105 is affixed 160 to the base second side portion 80 and each fiber 100 distal end portion 110 is free 165, each fiber 100 proximal end portion 105 is spaced apart 170 from an adjoining fiber 100 proximal end portion 105 by at least a fiber 100 thickness 135 forming an open volume 175, and further each fiber 100 has a length 140 of at least ten (10) times of the fiber 100 thickness 135, all as best shown in FIG. 7.

As can be deducted from the above, the plurality of fibers 100 are relatively tall and are of a loose density to allow debris 65 to fall easily toward the base 70 and away from the distal end portions 110 that come into contact with the shoe heel 60 or article 55, to minimize heel 60 or article 55 abrasion from the debris 65, as compared to a conventional floor carpet that would have a shorter denser plurality of fibers for better long term wear, this is as opposed to the present invention which isn't concerned with wear as it is easily washable or replaceable, wherein attached wall to wall floor carpet is not easily replaceable or washable.

Also included in the area pad 30 is a low friction layer 180 affixed 185 to the base 70 first side portion 75, wherein the low friction layer 180 is in contact 190 with the surface 40, wherein the layer 180 allows free relative movement 200 between the layer 180 and the surface 40, see FIGS. 7 through 9. Also included in the area pad 30 is a flexible binding 205 affixed 210 to the outer periphery 85, wherein the binding 205 is in contact 220 with a portion of the fiber 100 proximal end portions 105 being operational to substantially position 225 each longitudinal axis 155 perpendicular to the planar base 70, also as best shown in FIG. 7. The preferred construction of the area pad 30 is a MOHAWK model number Y2734, wherein the base 70 is made of nylon or a suitable water proof equivalent and the layer 180 is made of a flexible and smooth plastic or rubber or equivalent that is waterproof and has low friction with the surface 40.

Alternatively, on the area pad 30 that is adapted to be movably positioned 50 upon the surface 40 wherein in relation to the plurality of fibers 100, each fiber 100 distal end portion 110 can be expanded 115 in thickness 135 such that adjacent distal end portions 110 that are expanded 115 are in contact 120 with one another, as best shown in FIG. 7. Wherein operationally, the expanded 115 distal end portions 110 flex 125 to allow debris 65 to fall into the open volume 175 between the spaced apart 170 proximal end portions 105 and the expanded 115 distal end portions 110, which act to provide a partial barrier 130 between the debris 65 and the article 55, also as best shown in FIG. 7. As a further refinement on the expanded 115 distal end portions 110 of the plurality of fibers 100 for the area pad 30, the expanded 115 in thickness 135 distal end portion 110 does not exceed about one-half 145 of the length 140 to leave an adequate open volume 175 for the debris 65 to reside within, again reference FIG. 7.

On the plurality of fibers 100, the expansion 115 in thickness 135 of the distal end portion 110 can be accomplished by abrading the distal end portions 110 as a group with a mechanical rotating drum cylinder that can have a course exterior surface similar to course sandpaper, wherein the rotating drum is positioned in a moving and forceable contact with the distal end portions 110 which in effect frays the distal end portions 110 or causes fibrils to form which results in the thickness 135 expansion 115. The moving and forceable contact comes from wrapping the pad 30 around a portion of the rotating cylinder with the distal end portions 110 facing the cylinder, wherein the pad 30 is moved as against the cylinder in a direction opposite of the cylinder rotation direction. The preferred materials of construction for the plurality of fibers 100 is nylon, or other waterproof alternatives.

As an alternative embodiment for the area pad 30, or more specifically the shoe heel protection carpet 35, again as shown in FIGS. 1 through 9, that is adapted to be movably positioned 50 upon the vehicle floor 45, wherein the shoe heel protection carpet 35 includes a generally square shaped 90 flexible planar base 70 including a first planar side portion 75, a second planar side portion 80, and an outer periphery 85 conforming to the generally square shape 90, see specifically FIGS. 2 and 4. More specifically, for the shoe heel protection carpet 35, wherein the base 70 generally square shape 90 is sized dimensionally 95 in the range of about two (2) inches by two (2) inches to about eight (8) inches by eight (8) inches, see FIGS. 2 and 4.

Further, the shoe heel protection carpet 35 includes a plurality of fibers 100 each having a proximal end portion 105 and an oppositely disposed distal end portion 110, also each fiber 100 having a thickness 135 perpendicular 150 to a length 140 that is co-axial to a longitudinal axis 155 that extends from the proximal end portion 105 to the distal end portion 110, as best shown in FIG. 7. Wherein each fiber 100 proximal end portion 105 is affixed 160 to the base second side portion 80 and each fiber 100 distal end portion 110 is free 165, each fiber 100 proximal end portion 105 is spaced apart 170 from an adjoining fiber 100 proximal end portion 105 by at least a fiber 100 thickness 135 forming an open volume 175, and further each fiber 100 has a length 140 of at least ten (10) times of the fiber 100 thickness 135, all as best shown in FIG. 7.

As can be deducted from the above, the plurality of fibers 100 are relatively tall and are of a loose density to allow debris 65 to fall easily toward the base 70 and away from the distal end portions 110 that come into contact with the shoe heel 60 or article 55, to minimize heel 60 or article 55 abrasion from the debris 65, as compared to a conventional floor carpet that would have a shorter denser plurality of fibers for better long term wear, this is as opposed to the present invention which isn't concerned with wear as it is easily washable or replaceable, wherein attached wall to wall floor carpet is not easily replaceable or washable.

Also included in the shoe heel protection carpet 35 is a low friction layer 180 affixed 185 to the base 70 first side portion 75, wherein the low friction layer 180 is in contact 190 with the surface 40, wherein the layer 180 allows free relative movement 200 between the layer 180 and the surface 40, see FIGS. 7 through 9. Also included in the area pad 30 is a flexible binding 205 affixed 210 to the outer periphery 85, wherein the binding 205 is in contact 220 with a portion of the fiber 100 proximal end portions 105 being operational to substantially position 225 each longitudinal axis 155 perpendicular to the planar base 70, also as best shown in FIG. 7. Wherein operationally the low friction layer 180 allows the base 70 to partially move 230 relative to the vehicle floor 45 with movement 235 of the shoe heel 60 to lessen a relative movement 240 as between the plurality of fibers 100 and the shoe heel 60, thus reducing the abrasion potential to the shoe heel 60 via reduced relative movement 240.

In addition, optionally on the shoe heel protection carpet 35, the binding 205 further partially encases 215 the layer 180 at the outer periphery 85 to operationally to further facilitate free movement 230 of the base 70 relative to the vehicle floor 45, as best shown in FIG. 7. On the material of construction for the binding 205 it is preferably nylon that can be taped or stitched to the base 70, other material of attachment methods would be acceptable also that are machine washable. The preferred construction of the protection carpet 35 is a MOHAWK model number Y2734, wherein the base 70 is made of nylon or a suitable water proof equivalent and the layer 180 is made of a flexible and smooth plastic or rubber or equivalent that is waterproof and has low friction with the surface 40.

In referencing FIGS. 8 and 9, as opposed to the prevailing auto floor mat technology which is always looking for ways to securely attach the floor mat and/or heel support to the vehicle floor, the present invention does just the opposite in having a loose and non-attached 245 layer 180 and binding 205 to the vehicle floor 45, which facilitates the shoe heel protection carpet 35 being able to move across the vehicle floor 45 as when lateral force is placed upon the shoe heel protection carpet 35 from shoe heel 60 movement 235, a portion of the movement 235 is taken up in movement 230, thus reducing movement 240, which has the potential for shoe heel 60 abrasion, in effect reducing the shoe heel 60 abrasion. A conventional shoe heel type pad for automotive use, as described in the field and background portion is affixed to the vehicle floor, thus translating the full shoe heel movement 240 into abrasive movement, which acts to increase abrasion as against the shoe heel 60.

Thus, for the shoe heel protection carpet 35 that is adapted to be movably positioned 50 upon the vehicle floor 45, wherein due to the shoe heel protection carpet 35 not being attached at all 245 to the vehicle floor 45, the shoe heel protection carpet 35 is manually instantly movable 250 as against the vehicle floor 45 as the layer 180 and the binding 205 have no attachment to the vehicle floor 45 at all. This allows the shoe heel protection carpet 35 to be easily repositioned relative to the shoe heel 60, which is desirable when a portion of the plurality of fibers 100 become full of debris 65, another area clean of debris 65 can be substituted easily, noting that with a conventional auto floor shoe heel protector this would not be possible or more difficult at the very least with the shoe heel protector attached to the auto floor.

To further add to the convenience of cleaning the shoe heel protection carpet 35, and in going along with the ability to easily remove the shoe heel protection carpet 35 as there is no attachment 245 of the shoe heel protection carpet 35 to the vehicle floor 45, the shoe heel protection carpet 35 can be easily removed from the vehicle floor 45 and placed into a conventional washing machine to be washed as the shoe heel protection carpet 35 is waterproof. Note that this easy mode of thoroughly cleaning the protection carpet is not available for a conventional auto floor shoe heel protector, as firstly they are not easily removable nor are they typically machine washable.

Alternatively, on the shoe heel protection carpet 35 that is adapted to be movably positioned 50 upon the surface 40 wherein in relation to the plurality of fibers 100, each fiber 100 distal end portion 110 can be expanded 115 in thickness 135 such that adjacent distal end portions 110 that are expanded 115 are in contact 120 with one another, as best shown in FIG. 7. Wherein operationally, the expanded 115 distal end portions 110 flex 125 to allow debris 65 to fall into the open volume 175 between the spaced apart 170 proximal end portions 105 and the expanded 115 distal end portions 110 act to provide a partial barrier 130 between the debris 65 and the article 55, also as best shown in FIG. 7. As a further refinement on the expanded 115 distal end portions 110 of the plurality of fibers 100 for the area pad 30, the expanded 115 in thickness 135 distal end portion 110 does not exceed about one-half 145 of the length 140 to leave an adequate open volume 175 for the debris 65 to reside within, again reference FIG. 7.

On the plurality of fibers 100, the expansion 115 in thickness 135 of the distal end portion 110 can be accomplished by abrading the distal end portions 110 as a group with a mechanical rotating drum cylinder that can have a course exterior surface similar to course sandpaper, wherein the rotating drum is positioned in a moving and forceable contact with the distal end portions 110 which in effect frays the distal end portions 110 or causes fibrils to form which results in the thickness 135 expansion 115. The moving and forceable contact comes from wrapping the shoe heel protection carpet 35 around a portion of the rotating cylinder with the distal end portions 110 facing the cylinder, wherein the shoe heel protection carpet 35 is moved as against the cylinder in a direction opposite of the cylinder rotation direction. The preferred materials of construction for the plurality of fibers 100 is nylon, or other waterproof alternatives.

### CONCLUSION

Accordingly, the present invention of an area pad has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. An area pad adapted to be movably positioned upon a surface, wherein said area pad supports an article, said area pad comprising:
(a) a flexible planar base including a first side portion, a second side portion, and an outer periphery;
(b) a plurality of fibers each having a proximal end portion and an oppositely disposed distal end portion, further each fiber having a thickness perpendicular to a length that is co-axial to a longitudinal axis that extends from said proximal end portion to said distal end portion, wherein each fiber proximal end portion is affixed to said base second side portion and each fiber distal end portion is free, each said fiber proximal end portion is spaced apart from an adjoining fiber proximal end portion by at least a fiber thickness forming an open volume, and each fiber has a length of at least ten (10) times of said fiber thickness;
(c) a low friction layer affixed to said base first side portion, wherein said low friction layer is in contact with the surface, wherein said layer allows free relative movement between said layer and the surface; and
(d) a flexible binding affixed to said outer periphery, wherein said binding is in contact with a portion of said fiber proximal end portions being operational to substantially position each said longitudinal axis perpendicular to said planar base.

2. An area pad adapted to be movably positioned upon a surface according to claim 1 wherein each said fiber distal end portion is expanded in thickness such that adjacent distal end portions are in contact with one another, wherein operationally said expanded distal end portions flex to allow debris to fall into said open volume between said proximal end portions and said expanded distal end portions act to provide a partial barrier between the debris and the article.

3. An area pad adapted to be movably positioned upon a surface according to claim 2, wherein said expanded in thickness distal end portion does not exceed about one-half of said length to leave an adequate said open volume.

4. A shoe heel protection carpet adapted to be movably positioned upon a vehicle floor for supporting a shoe heel, said shoe heel protection carpet comprising:
(a) a generally square shaped flexible planar base including a first planar side portion, a second planar side portion, and an outer periphery conforming to said generally square shape;
(b) a plurality of fibers each having a proximal end portion and an oppositely disposed distal end portion, further each fiber having a thickness perpendicular to a length that is co-axial to a longitudinal axis that extends from said proximal end portion to said distal end portion, wherein each fiber proximal end portion is affixed to said base second side portion and each fiber distal end portion is free, each said fiber proximal end portion is spaced apart from an adjoining fiber proximal end portion by at least a fiber thickness forming an open volume, and each fiber has a length of at least ten (10) times of said fiber thickness;
(c) a low friction layer affixed to said base first side portion, wherein said low friction layer is in contact with the vehicle floor, wherein operationally said low friction layer facilitates free movement of said base relative to the vehicle floor; and
(d) a flexible binding affixed to said outer periphery, wherein said binding is in contact with a portion of said fiber proximal end portions being operational to substantially position each said longitudinal axis perpendicular to said planar base, wherein operationally said low friction layer allows said base to partially move relative to the vehicle floor with movement of the shoe heel to lessen a relative movement as between said plurality of fibers and the shoe heel.

5. A shoe heel protection carpet adapted to be movably positioned upon a vehicle floor according to claim 4, wherein said base generally square shape is sized in the range of about two (2) inches by two (2) inches to eight (8) inches by eight (8) inches.

6. A shoe heel protection carpet adapted to be movably positioned upon a vehicle floor according to claim 5, wherein said shoe heel protection carpet is manually instantly movable as against the vehicle floor as said layer and said binding have no attachment to the vehicle floor.

7. A shoe heel protection carpet adapted to be movably positioned upon a vehicle floor according to claim 6, wherein said shoe heel protection carpet is waterproof so as to be machine washable.

8. A shoe heel protection carpet adapted to be movably positioned upon a vehicle floor according to claim 7 wherein each said fiber distal end portion is expanded in thickness such that adjacent distal end portions are in contact with one another, wherein operationally said expanded distal end portions flex to allow debris to fall into said open volume between said proximal end portions and said expanded distal end portions act to provide a partial barrier between the debris and the shoe heel.

9. A shoe heel protection carpet adapted to be movably positioned upon a vehicle floor according to claim 8, wherein said expanded in thickness distal end portion does not exceed about one-half of said length to leave an adequate said open volume.

10. A shoe heel protection carpet adapted to be movably positioned upon a vehicle floor according to claim 9 wherein said binding further partially encases said layer at said outer periphery to operationally to further facilitate free movement of said base relative to the vehicle floor.
